(19) United States
(12) Patent Application Publication
(10) Pub. No.: US 2013/0311968 A1
(43) Pub. Date: Nov. 21, 2013

(54) Methods And Apparatus For Providing Predictive Analytics For Software Development

(71) Applicant: Manoj Sharma, Sunnyvale, CA (US)

(72) Inventor: Manoj Sharma, Sunnyvale, CA (US)

(21) Appl. No.: 13/673,983

(22) Filed: Nov. 9, 2012

Related U.S. Application Data
(60) Provisional application No. 61/557,891, filed on Nov. 9, 2011.

(51) Int. Cl. G06Q 10/06

(52) U.S. Cl. CPC G06Q 10/06
USPC 717/101

(57) ABSTRACT

Managing large software projects is a notoriously difficult task. It is very difficult to project how long it will take to design, develop, and test the software thoroughly enough before it can be shipped to customers. To help with the task of software development, an advanced predictive analytics system is introduced. The predictive analytics system extracts metrics on code complexity, code churn, new features, testing, and bug tracking from a software development project. These extracted metrics are then provided to predictive analysis engine. The predictive analysis engine processes the extracted metrics in view of historical software development experience collected in a representative model. The predictive analysis engine outputs useful predictions such as future bug discover rates, customer found defects, and the probability of hitting a schedule ship date with a desired quality level.

### RELATED APPLICATIONS

The present patent application claims the benefit of the previous U.S. Provisional Patent Application entitled “Methods and Apparatus for Providing Predictive Analytics for Software Development” filed on Nov. 9, 2011 having Ser. No. 61/557,891.

### TECHNICAL FIELD

The present invention relates to the field of computer software development. In particular, but not by way of limitation, the present invention discloses techniques for analyzing software development and predicting software defect rates for planning purposes.

### BACKGROUND

Managing computer software development is a notoriously difficult task that has been studied for many years. Predicting how long it will take to develop, test, and debug a particular software product is often more art than science. The difficulties in planning, scheduling, and managing software development have long caused problems for software development teams since these software development teams must also interact with customers and marketing teams that want to have reliable software development schedules for planning purposes.

For example, software development teams often have a difficult time in projecting an accurate release date for a new software product since the amount of time required to create a software application is difficult to estimate. Compounding this problem is the fact that the amount of time required to thoroughly test and debug a new software product is also a very difficult task to forecast. The lack of an accurate release date makes it difficult to marketing and advertising teams to plan their sales campaigns. The lack of an accurate release date also complicates the financial planning for a company since it is not known how much software development will cost and when revenue from a product release will begin to be collected.

Even after a software product is eventually released, it can be very difficult to manage the support of that released software product. The management of a released software product is very difficult due to the inability to accurately determine the amount of support staff that will be required to fix the bugs that customers find within a newly released software product. Proper post-release planning is required because if a newly released software product is not properly supported then the reputation of the newly release software product and the company that created the software product will suffer.

The difficulties in forecasting software development schedules and forecasting the amount of post-release support that will be required for a software product has long made software development a very difficult business risk. Thus, it would be desirable to improve the techniques for software development and release planning

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a computer system within which a set of instructions, for causing the machine to perform any one or more of the methodologies discussed herein, may be executed.

FIG. 2 illustrates a high-level conceptual diagram of predictive analytics.

FIG. 3A illustrates a graph describing various traditional approaches to predictive analytics for software development.

FIG. 3B illustrates a graph describing what may happen when a previous simple project is used to make predictions about a later more complex software project.

FIG. 4 illustrates a number of the problems with current bug rate only predictive analytics.

FIG. 5A illustrates a set of source code complexity metrics that can be extracted from the software source code.

FIG. 5B illustrates a set of code churn metrics that may be extracted from a software source code control system and a bug tracking system.

FIG. 5C illustrates a set of process metrics that may be extracted from various code tracking systems such as bug trackers, testing systems and feature trackers.

FIG. 5D illustrates a pair of code check-in graphs for code orphan analysis.

FIG. 5E illustrates a block diagram of a computer software predictive analytics system integrated with other software development tools.

FIG. 6 conceptually illustrates the improved predictive analytics system.

FIG. 7A illustrates a high-level block diagram that describes the operation of the improved predictive analytics system.

FIG. 7B illustrates more detail on the predictive analysis engine portion of FIG. 7A.

FIG. 7C conceptually illustrates processing previous case data to create a representative data model.

FIG. 7D conceptually illustrates combining current project data with representative data model to generate predictions.

FIG. 7E conceptually illustrates one particular method combining current project data with representative data model to generate predictions.

FIG. 8 illustrates results from an example application of the improved predictive analytics system.

FIG. 9 illustrates some of the other predictions that can be made with the predictive analytics system.

FIG. 10 illustrates a flow diagram describing the operation of a predictive analytics system for software development.

FIG. 11 illustrates an example of a graphical display of a specific bug forecast prediction that may be provided by the predictive analytics system.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. For example, although some of the example embodiments are disclosed with specific reference to computer software development, many of the teachings of the present disclosure may be used in many other environments that involve scheduling the development and support of complex projects wherein various project metrics can be obtained. For example, a complex construction project that involves many different subcontractors may use many of the same techniques for managing the construction project. The example embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Computer Systems

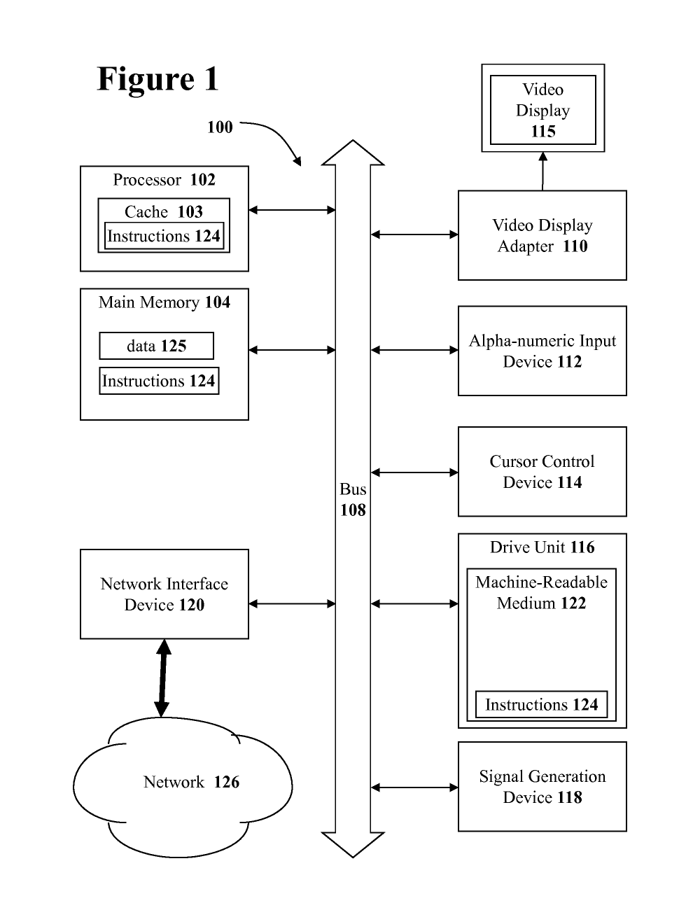

The present disclosure concerns techniques for improving the scheduling and support of software development projects. To monitor the software development, computer systems may be used. FIG. 1 illustrates a diagrammatic representation of a machine in the example form of a computer system 100 that may be used to implement portions of the present disclosure. Within computer system 100 of FIG. 1, there are a set of instructions 124 that may be executed for causing the machine to perform any one or more of the methodologies discussed within this document. Furthermore, while only a single computer is illustrated, the term “computer” shall also be taken to include any collection of machines that individually or jointly execute a set (or multiple sets) of instructions to perform any one or more of the methodologies discussed herein.

The example computer system 100 of FIG. 1 includes a processor 102 (e.g., a central processing unit (CPU), a graphics processing unit (GPU) or both) and a main memory 104 and a static memory 106, which communicate with each other via a bus 108. The computer system 100 may further include a video display adapter 110 that drives a video display system 115 such as a Liquid Crystal Display (LCD). The computer system 100 also includes an alphanumeric input device 112 (e.g., a keyboard), a cursor control device 114 (e.g., a mouse or trackball), a disk drive unit 116, a signal generation device 118 (e.g., a speaker) and a network interface device 120. Note that not all of these parts illustrated in FIG. 1 will be present in all embodiments. For example, a computer server system may not have a video display adapter 110 or video display system 115 if that server is controlled through the network interface device 120.

The disk drive unit 116 includes a machine-readable medium 122 on which is stored one or more sets of computer instructions and data structures (e.g., instructions 124 also known as ‘software’) embodying or utilized by any one or more of the methodologies or functions described herein. The instructions 124 may also reside, completely or at least partially, within the main memory 104 and/or within a cache memory 103 associated with the processor 102. The main memory 104 and the cache memory 103 associated with the processor 102 also constitute machine-readable media.

The instructions 124 may further be transmitted or received over a computer network 126 via the network interface device 120. Such transmissions may occur utilizing any one of a number of well-known transfer protocols such as the well known File Transport Protocol (FTP). While the machine-readable medium 122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories, optical media, and magnetic media.

For the purposes of this specification, the term “module” includes an identifiable portion of code, computational or executable instructions, data, or computational object to achieve a particular function, operation, processing, or procedure. A module need not be implemented in software; a module may be implemented in software, hardware/circuitry, or a combination of software and hardware.

Traditional Approach

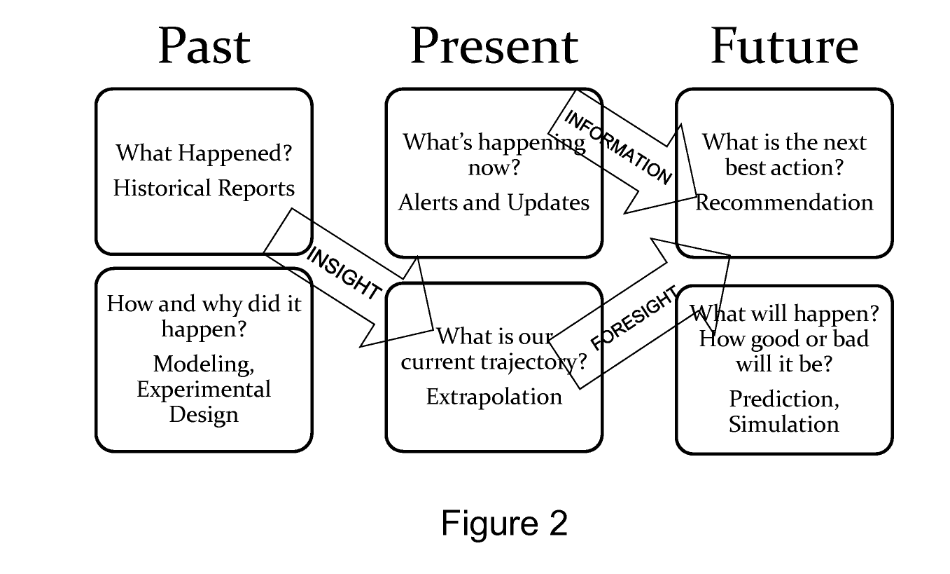

Predictive analytics is the analysis of recent operations to predict future outcomes, using information learned from experience in the past. After creating a set of predictions, a user of a predictive analytics system may then take corrective action to avoid a predicted detrimental future outcome. Specifically, analysis of recent operations is used to determine future outcomes, based on past behavior so that corrective action can be taken today. This is graphically illustrated in FIG. 2.

Referring to FIG. 2, a set of historical reports on what happened in the past is used to create a model for how things generally operate. This historical information provides insight into the present. In the present, a set of informational metrics are kept track of to quantify the current situation and the current trajectory.

Combining the insight from the past with the informational metrics from the present provides foresight such that predictions of the future can be made. Based upon the predictions of the future, a manager can take corrective action which will change the predicted outcome of the future. Thus, predictive analytics provides a substantial amount of information that can help software managers and executives including product ship dates, customer satisfaction, revenue estimates, etc.

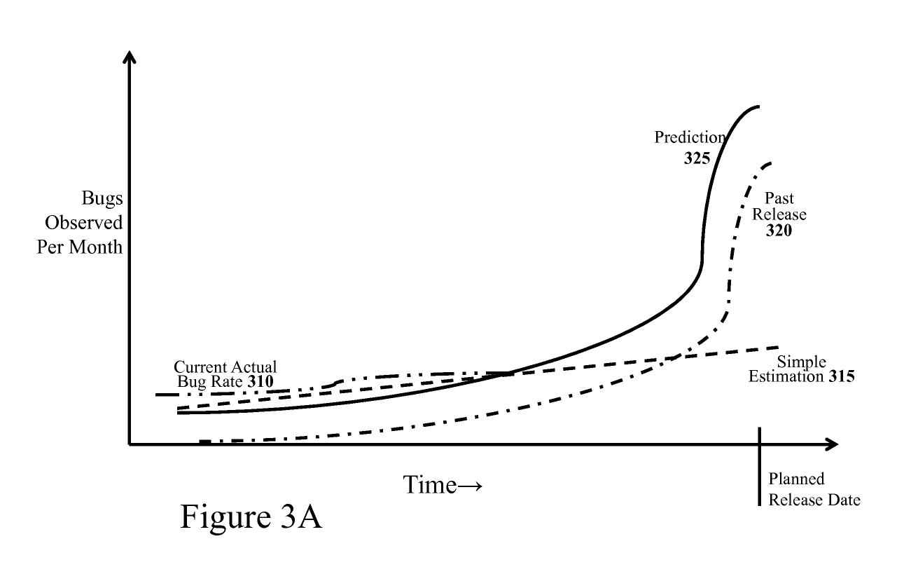

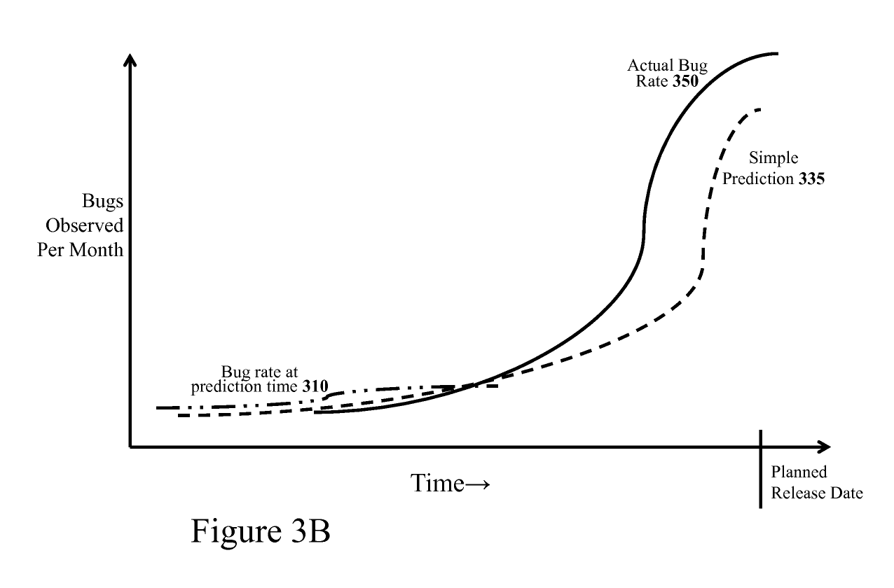

The traditional approach of performing predictive analytics for planning and scheduling a software project is based upon simple bug tracking All of the bugs discovered within a software program being developed are tracked with a bug tracking system and the rate at which bugs are being discovered provides some guidance as to how the software development is proceeding. FIG. 3A illustrates a graph describing various traditional approaches to predictive analytics using simple bug tracking

An actual bug rate 310 may be linearly extrapolated to form the simple estimation 315 of the bug rate at the release date as illustrated in FIG. 3A. However, this very simple estimation 315 is likely to provide extremely inaccurate results since more software bugs are typically discovered near the project completion time and as the amount of testing increases as the release date approaches.

The current actual bug rate may be compared to bug rates of previous products to come up with a revised bug prediction. For example, one may scale last year's bug rate curve 320 to match this year's current bug rate data 310 to generate an improved bug prediction 325. This improved bug prediction 325 is likely to be better than the simple linear estimation 315 since the improved bug prediction 325 more accurately incorporates the realities of software development processes. However, this improved bug prediction 325 is also likely to be inaccurate since every software project is different and just a simple mapping of a previous bug rate 320 onto a current bug rate will result only in a simple prediction that will only be accurate if the two development scenarios are very similar.

However, most software development projects are very different from each other. For example, what if the current software development project was attempting to add several more complex features than the previous software development projects? The more complex current software development project would likely lead to more bugs. Thus, FIG. 3B illustrates a graph describing what may happen when experience from an earlier simple software project is used to create a simple prediction 335 for a later software development project that is much more complex. As illustrated in FIG. 3B the actual bug rate 350 for the later more complex project will likely be much higher than the simple predicted bug rate 335 since the predictions about the new complex project failed to take into account the increased complexity of the new software development project.

Problems with the Traditional Approach

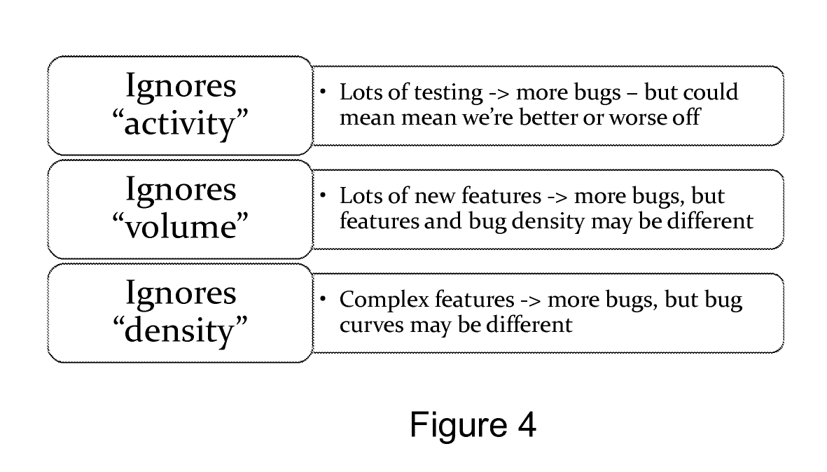

FIG. 4 illustrates a number of the problems with current bug rate only predictive analytics for software development projects. The current systems based only upon bug rates fail to include a large amount of other information that can greatly improve predictive analytics for software development projects.

The current bug rate only predictive analytics ignore too much of the activity that is occurring during the software development process. For example, the amount of testing being performed should be considered. If there is a large amount of testing the more bugs will be discovered. However, more bugs discovered due to more testing does not necessarily mean the code is worse that previous code; it is simply more thoroughly tested.

The current bug rate only predictive analytics systems also ignore the “volume” of software code being analyzed. If the current software development project is much larger than previous software development projects there will generally be more bugs in the current larger software development project. But if the larger number of bugs is proportional to the larger size of the current software development project, the larger number of bugs may not signal any significant problem with the current software development project. Furthermore, if a large number of new features are being added to the current software development project, these new features may be more vulnerable to having bugs than code written to implements well-known features that have been created in previous software projects.

The current bug rate only predictive analytics systems may also ignore the “density” of software code being analyzed. Equally sized software development projects may have different levels of complexity. For example, if a project has multiple different code threads that run on different cores of a processor and each thread must carefully interoperate with the other concurrently executing threads then such a software development project will be inherently more complex than single-threaded software program that runs on a single processor even if both software development projects have the same number of lines of code. Thus, one would expect to have more bugs in an inherently complex software development project.

A key insight here is that the traditional approach to predictive analytics that only uses bug rate tracking can have problems because software bugs are a lagging indicator. Software bugs only indicate problems that have been discovered and are poor indicators as to problems that will be encountered later. And depending on the specific context, bugs discovered during a software development project are both positive and negative indicators. For example, a larger number of bugs may actually be a positive indicator if this larger number of bugs was discovered by extremely thorough testing. Conversely, a large number of bugs may also indicate significant problems with the software being developed.

An Improved Approach Using More Information

To improve upon the predictive analytics for software development, the present disclosure discloses a predictive analytics system that collects much more information about the software development project to create significantly better predictions of future outcomes. The new information collected about the software project is combined with previously used indicators (such as bug rate tracking) in a synergistic manner that greatly improves the accuracy of the predictions that can be made. Recent research has revealed that there indeed are several software code metrics that are highly correlated with quality. Measuring these software code metrics and implementing them within a predictive analytics system can greatly improve the predictive analytics system.

Three different groups of significant factors have been identified as important and implemented in predictive analytics system: code complexity, code churn, development process factors. Code complexity may be defined as a set of metrics that may be extracted from the actual software code itself and which provide a measure as to the complexity of created software code. Code churn may be defined as the set of interactions between humans (programmers and testers) and the actual software code. Finally, the development process factors are a set of software development processes that affect the software development process such as the number of new features being added, the amount the code is exposed to consumers, the code ownership.

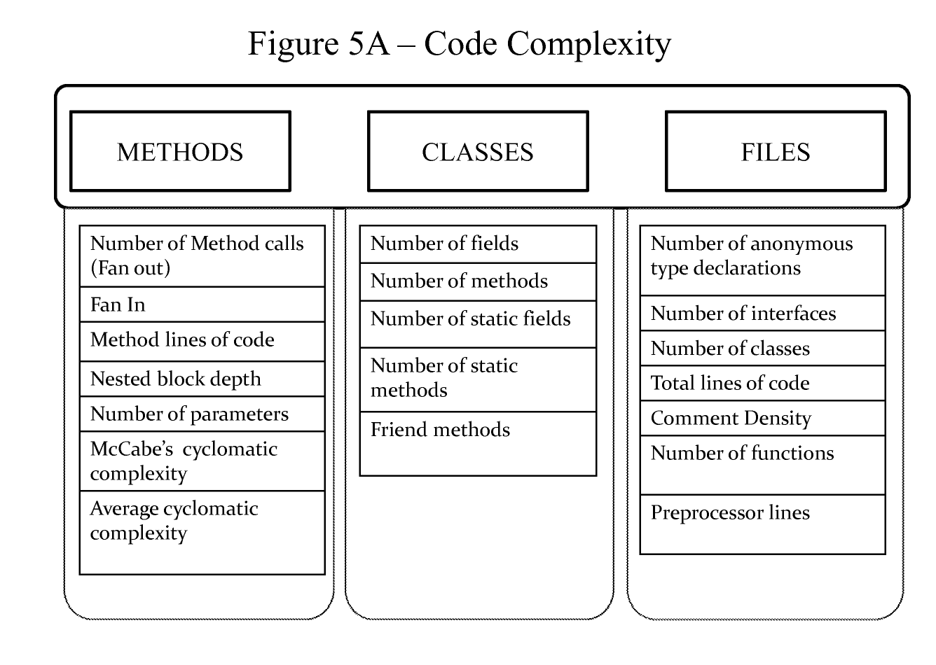

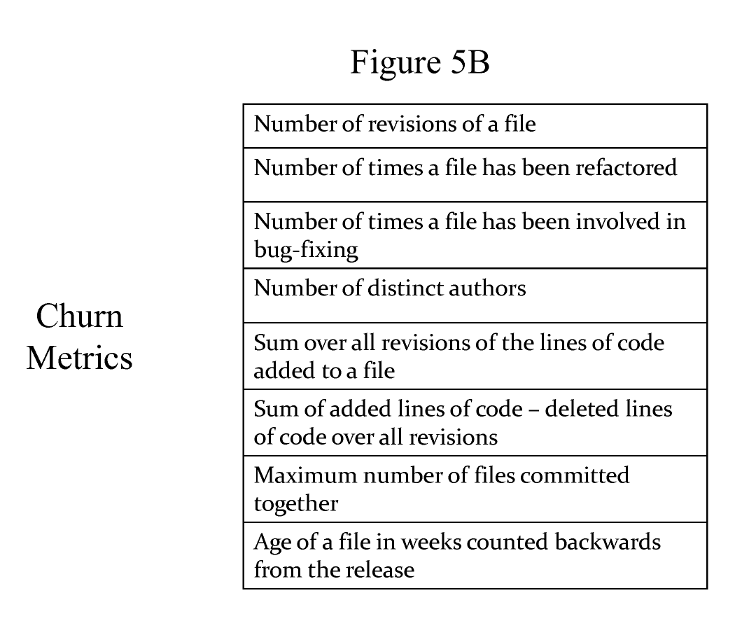

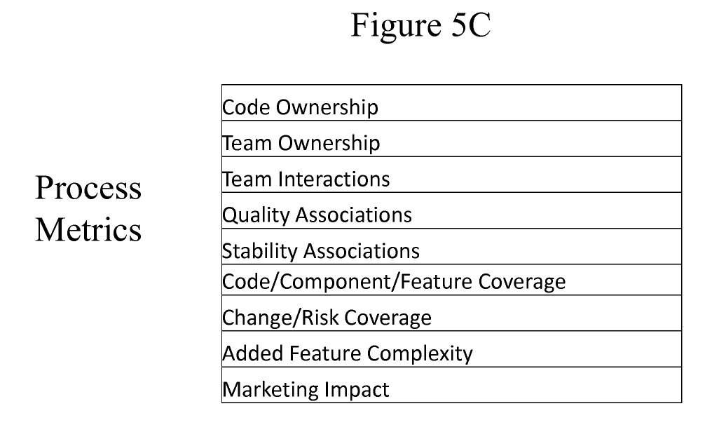

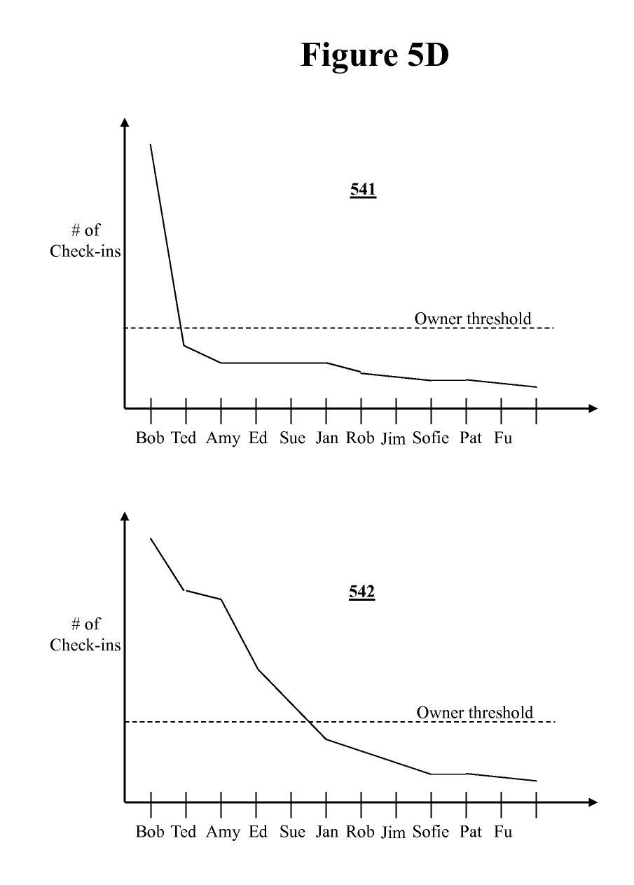

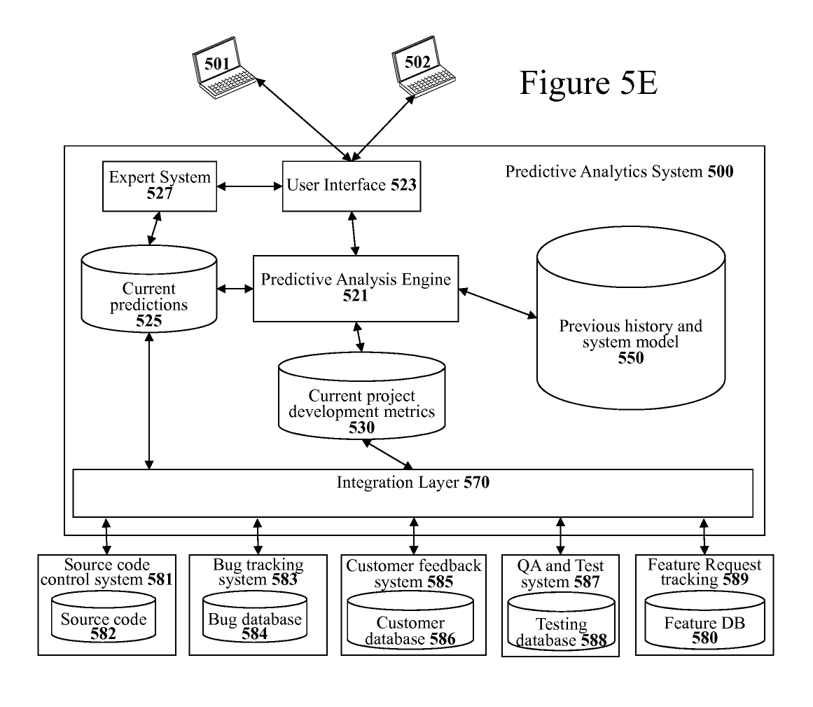

FIG. 5A illustrates a sample set of code complexity factors that may be extracted from the software source code itself. Various code complexity metrics that can be extracted from software methods include the number of method calls (fan out), the fan in, the method lines of code, the nested block depth of code, the number of parameters supplied to a method, the number of variables used, average cyclomatic complexity, maximum cyclomatic complexity, and McCabes's cyclomatic complexity. The classes defined in a software development project also provide a useful measure of code complexity. Complexity metrics that may be extracted from defined classes include the number of fields in a class, the number of methods in a class, the number of static fields, and the number of static methods. Complexity metrics that may be extracted from the software files in general include the number of anonymous type declarations, the number of interfaces, the types of interfaces, the number of variables, the number of classes, the total number of lines of code, and other metrics that can be generated by analyzing the code files.

The number of global variables written to in a software file is generally highly-correlated to the defect rate of software. With global variables, many different entities can access the global variable such that any one of them may cause an error and determining which one caused the error may be difficult. Note that these particular code complexity metrics listed in FIG. 5A are just an example of some of the software complexity metrics that may be extracted. Many other software code complexity metrics may be extracted and used in the predictive analytics system of the present disclosure.

All of these code complexity metrics may be collected on a localized basis (per method, per class, etc.) and used to perform local analysis for individual methods, classes, etc. In this manner, predictions made on local code regions may be used to allocate resources to code areas where there may be localized trouble. The code complexity metrics may also be combined together for a larger project basis view.

FIG. 5E illustrates a block diagram of a predictive analytics system 500 that may collect code complexity metrics in an automated manner. Specifically, an integration layer 570 provided access to various programming development tools. In particular, the integration layer 570 has access to the source code control system 581 such that it can access all of the source code 582 being developed. The integration layer 570 may collect code complexity metrics by accessing the source code 582 and running software code analysis programs that parse through the source code 582 to identify and count the desired code complexity metrics. In some embodiments, the software code analysis routines may be integrated with other existing software tools (such as editors, compilers, linkers, etc.) such that source code complexity metrics may be collected any time that revised source code is compiled or processed in other manners.

FIG. 5B illustrates a set of code churn metrics that may be collected and analyzed. The code churn metrics generally measure the interaction between programmers and the software code. The code churn metrics may include the number of revisions to a file/method/class/routine, the number times a file has been refactored, the number of different authors that have touched a file/method/class/routine, and the number of times a particular file/method/class/routine has been involved in a bug-fixing. Note again that keeping track of localized code churn information can help pinpoint the likely areas in a software project that may need extra attention.

Additional code churn metrics may include the sum of all revisions of the lines of code added to file, the sum of all lines of code minus the deleted lines of code over all revisions, the maximum number of files committed together, and the age of file in weeks counted backwards from the release time. In general, the less that a particular section of software code has been altered indicates that the software code is more likely to be stable. Furthermore, a series of relatively small or simple changes to a section of code, generally accompanied by testing (which also may be tracked) is correlated with fewer bugs for that code section.

Referring back to the predictive analytics system 500 diagram of FIG. 5E, many of the code churn metrics may be obtained from the data files associated with a source code control system 581 that is used to track and store the source code 582 of a software development project. In one embodiment, the CVS and Subversion source code control systems are directly supported. In one particular embodiment of a predictive analytics system 500, the source code control system 581 may be modified to track additional churn metrics that are not easily obtained from existing source code control systems.

The source code control system 581 tracks when any source code is changed, who changed the source code, a description of the changes made, an identifier token for the feature being added or the defect being fixed by the change, and any reviewers of the change. In addition, the system may determine the version branch impact of the code changes. In one embodiment, the system handles the existing version branching structure and can analyze the version branching without requiring any changes.

In addition to the source code control system 581, a bug tracking system 583 (also known as a defect tracking system) can provide a wealth of code churn information. For each bug that has been identified, the bug tracking system 583 may maintain a bug identifier token, a bug description, a title, the name of the person that found the bug, an identifier of the component with the bug, the specific version release with the bug, the specific hardware platform with the bug, the date the bug was identified, a log of changes made to address the bug, the name of the developer and/or manager assigned to the bug, whether the bug is interesting to a customer, the priority of the bug, the severity of the bug, and other custom fields. When a particular bug tracked by the bug tracking system 583 is addressed by a programmer, the programmer will indicate which particular bug was being addressed using the bug identifier token. The source code control system 581 may then update all the associated information such as the log of changes made to address the bug and the specific code segments modified. Thus, the number of times a code section has been modified due to bug-fixing can be tracked. If a bug is associated with a new feature being added, the system may also provide a link to the feature in the feature tracking system 589.

In one embodiment of the predictive analytics system 500 of the present disclosure, the predictive analytics system 500 may provide feedback directly into some of the programming support tools. For example, referring to FIG. 5E, after the predictive analytics engine 521 analyzes a current software development project, the predictive analytics engine 521 will store the prediction results in the current predictions database 525. The prediction results will include identifications of high risk areas of the source code. To provide feedback to the programmers, the integration layer 570 can read through the prediction results in the current predictions database 525 and change the contents of the programming support tools. For example, if a particular area of code is deemed to be a high-risk area of code, the integration layer 570 may access the bug tracking system 583 and increase the priority rating for bugs associated with the high risk area. Similarly, the integration layer 570 may access the feature request tracking system 589 and increase the complexity rating for feature if the code complexity metrics extracted from the associated source code indicates that the code is more complex than the current rating.

A third set of metrics that may be tracked are a set of software development process factors that may be referred to as ‘process’ metrics. These process metrics keep track of various activities that occur during software development such as testing, adding new features, “ownership” of code sections by various programmers, input from beta-testing sites, etc. FIG. 5C illustrates a list of process metrics that may be tracked by the predictive analytics system. These process metrics may include code ownership, team ownership, team interactions, quality associations, testing results, stability associations, code/component/feature coverage, change/risk coverage, added features, added feature complexity, marketing impact, along with others.

One particularly important process metric to analyze is “orphan” analysis of the source code. When one or two programmers work on a particular section of source code, those one or two programmers are said to “own” that code and tend to take responsibility for that code. However, if there is a section of code that is accessed by numerous different programmers, the various different programmers may make contradictory modifications to that section of code such that defects become more likely. FIG. 5D illustrates a pair of graphs illustrating the number of check-ins for a particular piece of code for a set of different programmers. In graph 541 only one programmer has enough check-ins over an owner threshold amount such that one programmer ‘owns’ the code section. In graph 542 five programmers have enough check-ins over the owner threshold amount such that several programmers appear to ‘own’ that code section. Since there are so many different alleged owners, the source code associated with graph 542 is deemed to be ‘orphan code’ that no one person owns. Thus, the source code associated with graph 542 may have development risks associated with it.

Referring again to FIG. 5E, new features may be traced by a new feature request tracking system 589 that maintains a feature database 580. When a new feature is added to the software product under development, a new entry in the feature database 580 is created. When source code 582 associated with a new feature is modified or added to the source code control system 581, the source code control system 581 is informed of the association with the new feature using and identifier. The number of new features and the amount of code that must be modified or added to implement these new features can have a significant impact on the difficult of a software development project. The number of new features can be used to normalize the number of bugs that are being discovered. For example, if a large number of new features are being added then it should not be surprising if there are a larger number of bugs compared to previous development efforts.

Brand new features are generally more difficult to create than well-known features such that the bug rates may be expected to be higher. In one embodiment, each new feature is rated with a complexity score. For example, each feature may be rated as high, medium, or low in complexity such that each new feature is not treated exactly the same since some new features are more difficult to add than others.

FIG. 5E also illustrates a quality assurance and testing system 587 that may be used to keep track of various quality assurance checks and testing regimes applied the software code being developed. The integration layer 570 may read the information from the quality assurance and testing system 587 and use this information to adjust the predictions being made. Code that has been extensively reviewed by others and/or tested will generally have a lower bug rate than code that has not been as well tested. The amount of testing performed on code sections may be integrated into a source code control system 581 such that amount of testing performed on each code section may be tracked.

The amount of marketing exposure can also be used to help track the progress of software development. Referring to FIG. 5E, a customer feedback system 585 may be used to track feedback reported by customers during beta-testing or after release. Feedback from customers is recorded in a customer database 586 along with a customer identifier for each piece of customer feedback. The number of different customers that report issues can be used as a gauge as to how much marketing exposure a particular software project has. This marketing exposure number can be used to help normalize the amount of issues within the code. If there are a large number of bugs from just a few different customers then the code may have significant problems. Alternatively, if there are relatively few bugs reported from a large number of customers then the software code is probably pretty stable. The bugs can also be weighted by time. For example, the number of new customer reported issues in the last three months can provide a good indication of the stability of the software code.

In summary, the present disclosure proposes tracking a much larger amount of information than is tracked by conventional bug tracking systems in order to improve predictive analytics during software development. Specifically, in addition to traditional bug tracking, an improved predictive analytics will track many code complexity features (that can generally be extracted from the source code), many code churn statistics describing the interaction between programmers and the source code (that can often be extracted from source code control systems), and many software development process metrics such as the number of new features being added, the amount of testing being performed on the various code sections, and feedback from customers.

Improved Predictive Analytics System

All of the metrics described in the previous section are collected and used within a predictive analytics system 500 that predicts the future progress of the software development. Specifically, all of the metrics described in the previous section are collected within a current project development metrics database 530. All of the metrics within the current project development metrics database 530 provide a deep quantified measure of how the software project development is progressing. A predictive analysis engine 521 processes information the current project development metrics database 530 along with a previous software development history and system model 550 to develop a set of current predictions 525 for the current software development project.

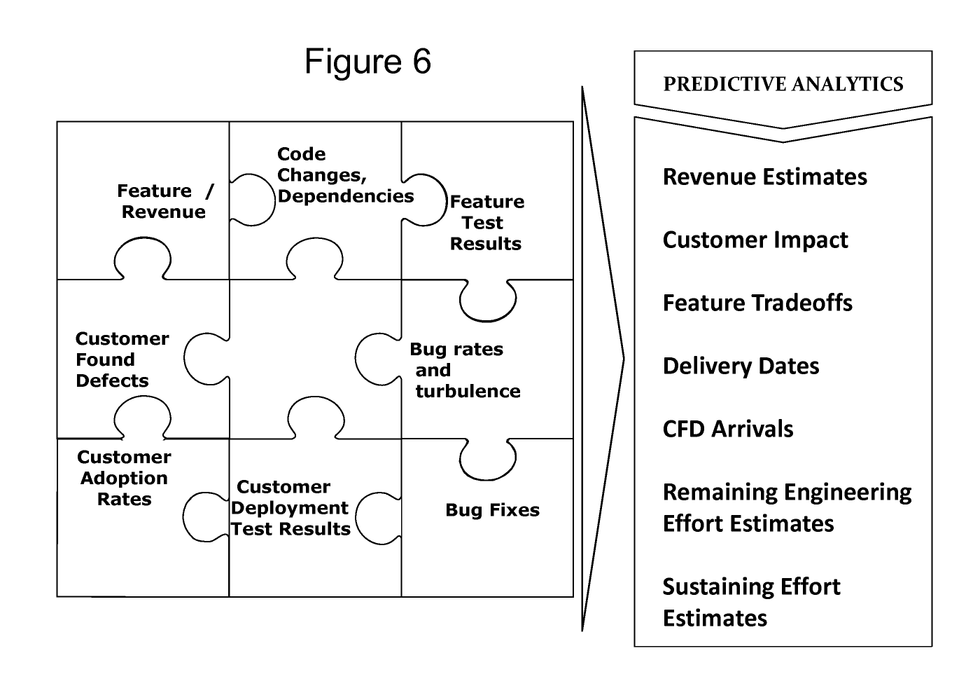

FIG. 6 conceptually illustrates the operation of the predictive analysis engine in the predictive analytics system. The left-hand side of FIG. 6 lists some of the information that is analyzed by the predictive analysis engine including: code changes, code dependencies, feature test results, bug rates, bug fixes, customer deployment test results, customer found defects (CFDs), features, etc. All of this data is processed along with a historical model of previous software development efforts in order to output predictive analytics that may be used by software managers and executives. The output can be used to help make revenue estimates, analyze customer impact, make feature trade-off decisions, estimate delivery dates, predict customer found defect (CFD) rates for the product when released, make remaining engineering effort allocation estimates, and sustaining (customer support) effort estimates.

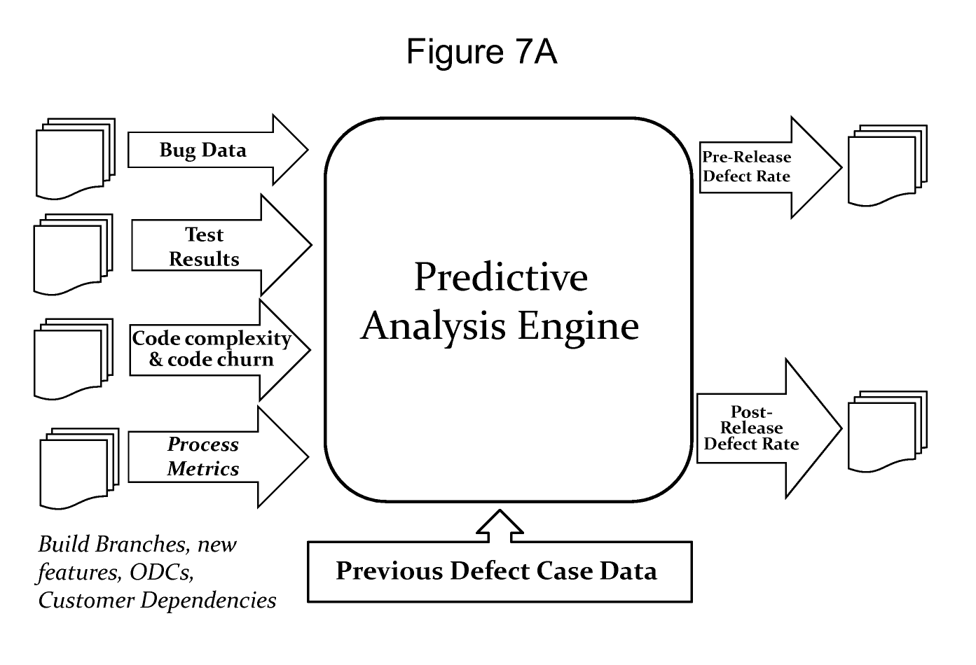

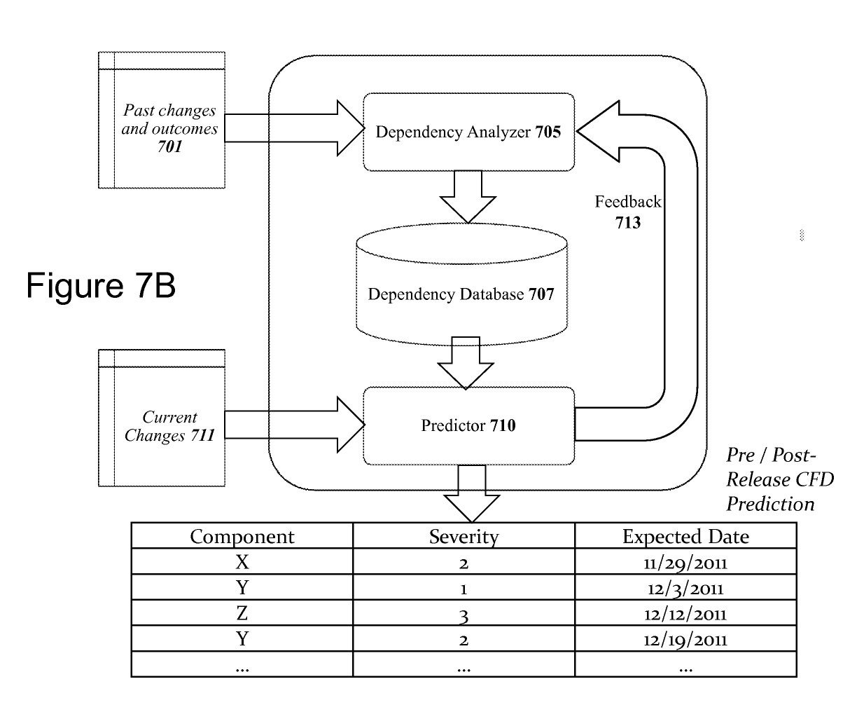

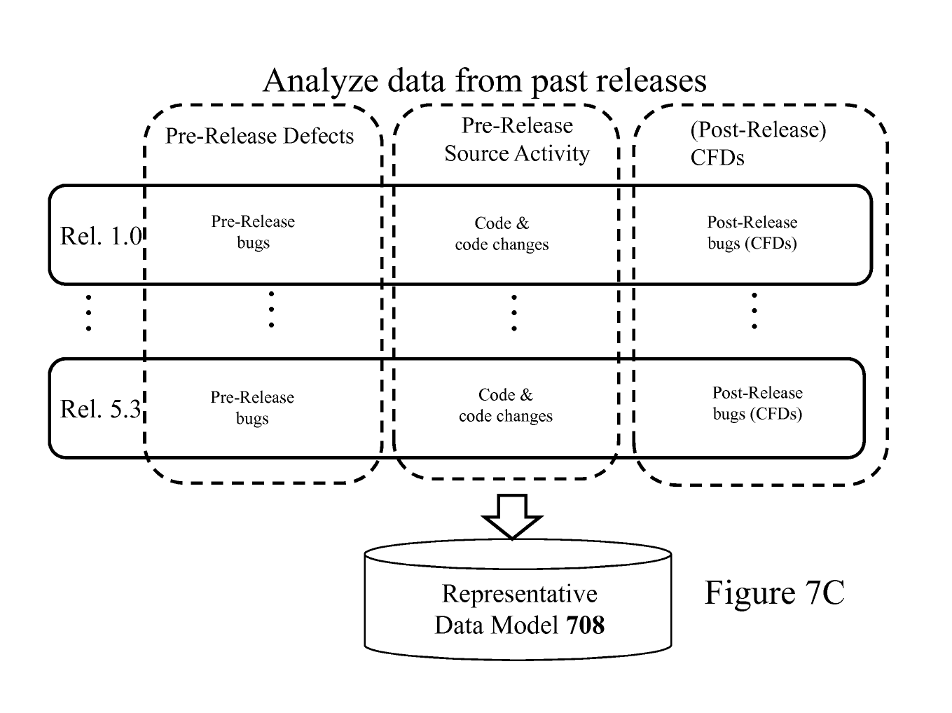

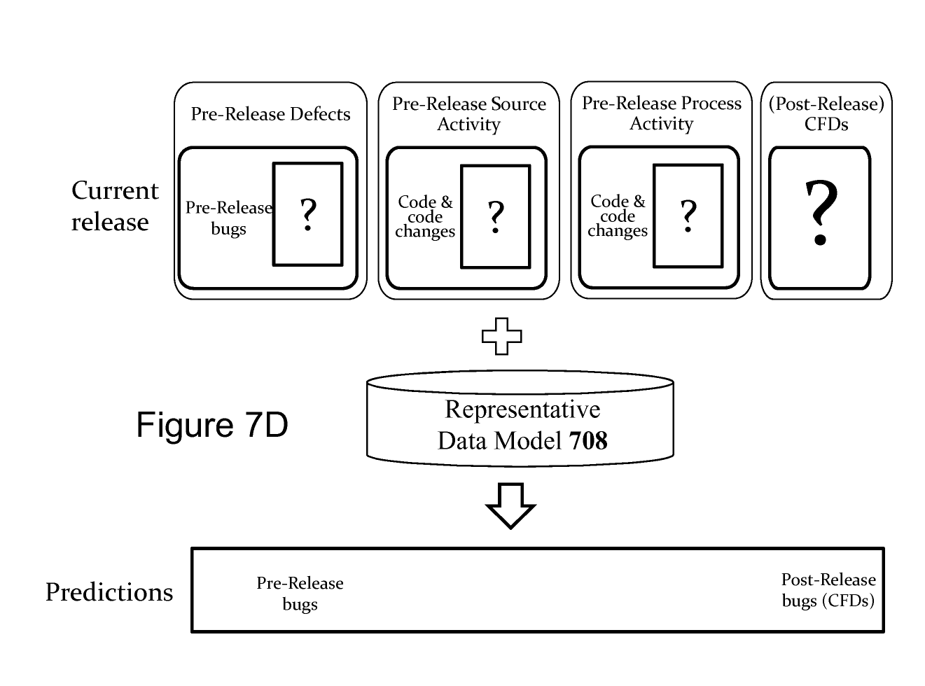

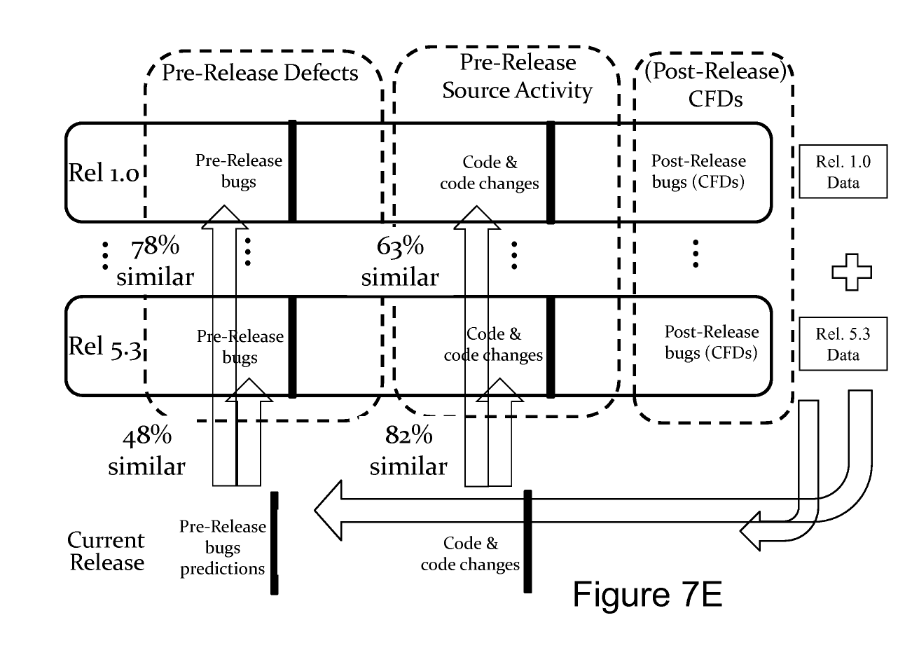

FIG. 7A illustrates a high-level block diagram that describes the operation of the predictive analysis engine. As illustrated on the left, all of the collected metrics on the current software project code is fed into a predictive analysis engine. The collected metrics include all of the standard bug tracking data that is traditionally used. In addition, metrics on testing results are provided to the predictive analysis engine to adequately reflect the current state of the code testing. All of the collected code complexity and code churn metrics are also provided to the predictive analysis engine. These code complexity and code churn metrics provide the system with project risk information that is not reflected in the existing bug tracking information. The software development process metrics are also provided.

At the bottom of FIG. 7A the predictive analysis engine is fed with previous case data such as previous internal and customer defect data for previous product releases. For example, the detailed bug rate data from the past release bug rate 320 in FIG. 3A may be provided as an example of the previous internal and customer defect data. The previous internal and customer defect data provides a historical experience data that may be used by the predictive analysis engine to help generate predictions for the current software project being analyzed.

The predictive analysis engine processes all of the data received to generate useful predictive analytic information. In FIG. 7A, two examples of predictive information are provided: a pre-release defect rate and post-release defect rate.

The pre-release defect rate information provided to the user may be used to guide the software development effort. For example, the pre-release defect rate may specify particular areas of software development project code that are more likely to have defects. This information can be used to allocate software development resources to those particular code sections. For example, more testing may be done on those code sections. If the predicted pre-release defect rate appears to be too high, the software project managers may decide to eliminate some new features in order to reduce the complexity of the software project in order to ensure a more stable software product upon release.

The post-release defect rate provides an estimate of how many customer found defects (CFDs) will be reported by customers. The post-release defect rate can be used to plan for the post-release customer support efforts. The number of customer support responders and programmers needed to address customer found defects may be allocated based on the post-release defect rate. If the predicted post-release defect rate is deemed too high, the release date of the product may be postponed to improve the product quality before release.

FIG. 7B illustrates more detail on one embodiment of the predictive analysis engine of FIG. 7A. At the top of FIG. 7B, a set of previous software development cases 701 are provided to a dependency analyzer 705 to create a dependency database 707. The past case information 701 includes past code changes (such as code complexity and code churn information) and outcomes (such as bug rates). FIG. 7C conceptually illustrates this process. In FIG. 7C, the set of previous case data including data for previous releases 1.0 to release 5.3 are provided to the dependency analyzer. The previous case data includes the pre-release defects (bug tracking), the pre-release source code activity (code complexity, code churn, etc.), and the observed post-release defect activity such as the customer found defects (CFDs). The dependency analyzer creates a representative data model 708 that forms the dependency database of FIG. 7B.

Referring again to the FIG. 7B, the dependency database 707 is used by a predictor 710 to analyze a current software project under development. Specifically, the current changes to a current software project 711 (code complexity metrics, churn metrics, process metrics, etc.) are provided to the predictor 710 that analyzes those changes. The predictor 710 consults the accumulated experience in the dependency database 707 in view of the current changes 711 to output a set of predictions about the current software project. The predictions may include predicted a set of customer found defects of various severity levels as illustrated in the example of FIG. 7B.

Note that as a project progresses, additional bug tracking information will be provided on the current project. This additional information can be used to create a feedback loop 713 to the dependency analyzer as depicted in FIG. 7B. The feedback loop may modify the dependency database 707 based upon the new information.

FIG. 7D conceptually illustrates the prediction process. As illustrated in FIG. 7D the pre-release defects (bug tracking) information, the pre-release source code activity (code complexity and code churn information), and the pre-release process activity is processed with the aid of the representative data model 708 created by the dependency analyzer 705. The output may comprise a prediction of future pre-release defects and a prediction of post-release customer found defects (CFDs). FIG. 7E conceptually illustrates an example of one particular prediction process. In the example of FIG. 7E, the current pre-release defects and current pre-release source code activity are compared with each of the previous historical cases to identify how similar the cases are. The predictor system then creates an output that is calculated as a weighted combination of comparisons to previous cases of software development.

Many different predictive analysis systems may be used to implement the predictor. For example, the statistical techniques of multi-collinearity, logistic regression, and hierarchical clustering maybe used to make predictions based on the previous data. Various different artificial intelligence techniques may also be used. For example, Bayesian inference, neural networks, and support vector machines may also be used to create new predictions based on the current project information (bug tracking, code complexity, code churn, etc.) in view of the experience data collected from previous projects that is stored within the representative data model.

In one particular embodiment, the primary techniques used in the predictor system include Principal Component Regression (one application of principal component analysis), factor analysis, auto regression, and parametric forms of defect curves. These particular techniques have proved to provide accurate defect forecasting results for both pre-release and post release defects in the software development project.

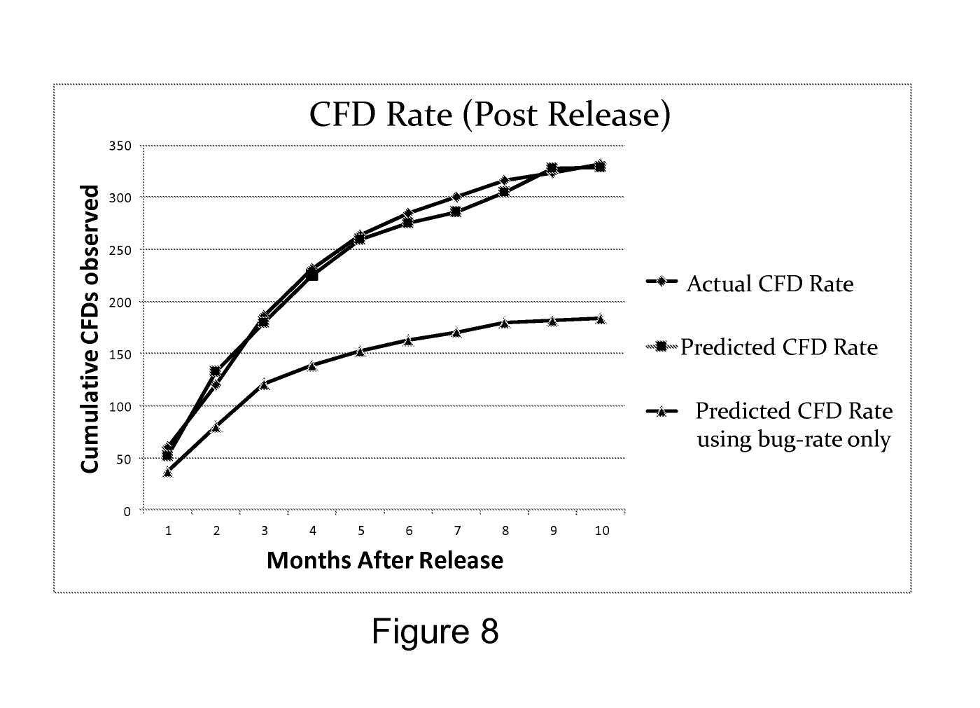

FIG. 8 illustrates results from an example application of the predictive analytics system of the present disclosure. At the release time for a software product, the source code, source code control system and bug tracking system were all analyzed to extract the relevant code complexity, code churn, bug rate, and other metrics. These software development metrics were then processed by a predictor that was able to draw from the experience stored in a representative data model. The predictor output a set of predicted customer found defects (CFDs) that would likely be reported in the months following the release of the software product. As illustrated in FIG. 8, the predicted customer found defects (CFDs) very closely tracked the actual customer found defects (CFDs) that were reported in the months following release.

For comparison, a set of simple predictions from a bug-tracking only based system is drawn on the same graph. As illustrated in FIG. 8, the improved predictive analytics system provided much more accurate predictions. Thus, by taking into consideration code complexity, code churn metrics, and process metrics that can easily be extracted from source code and source code control systems, the accuracy of predictions was greatly improved.

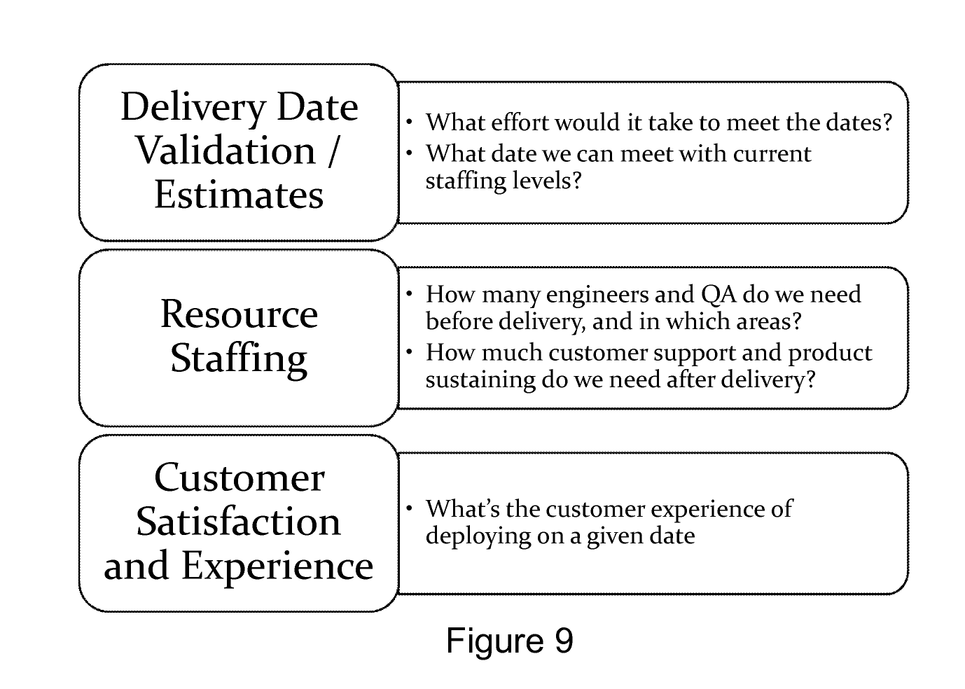

Customer found defects (CFDs) represent only one set of many other predictions can be made by the improved predictive analytics system. FIG. 9 illustrates some of the other predictions that can be made with the predictive analytics system. Other important predictions that may be made include ship-date confidence level. Given a desired quality metric and projected ship date, the improved predictive analytics systems can be used to generate a confidence level that specifies how likely it is that the product will be ready to ship by the projected ship date. Having such a confidence level allows financial planners to make revenue predictions based upon whether a product will ship or not.

The predictive analytics system can be used to determine a proper ship date given a quality standard that must be met. Having a projected ship date based upon empirical objective statistics that can be used to determine if a release date desired by executive management should be postponed or not. Without such an objective figure, internal office politics may allow poor decisions to be made on whether to ship a product or not.

The predictive analytics system can be used to determine the amount of resources that will likely be required to provide good post-release support for a product. Once a product ships, a software development project needs to hire support staff to handle support calls received from the customers of the product. Furthermore, engineering resources need to be allocated to the software development project in order to remedy the various customer found defects. Thus, the predictive analytics system can be used to make budgeting and hiring decisions for post-release customer support.

The improved predictive analytics system disclosed in this document can be used to significantly improve the software development process by providing objective analysis of the software development project and a set of objective predictions for the software development project. Providing objective analysis from an automated predictive analysis system can help remove many of the subjective decisions made by software managers that can be controversial and often very wrong. Traditional bug rate-only analysis is too simplistic to provide accurate results since reported bugs are lagging indicators that only describe defects that have already been found. By using other detailed information about a software project including code complexity, code churn, new features, and testing information in additional to traditional bug tracking much more accurate predictions can be made. Most of the additional information can easily be obtained by automated processing of the source code, retrieving information from source code control systems, retrieving information from testing databases, and retrieving information from feature request systems. This additional data reflects the future bug risk inherent in the software project instead of just the problems found so far with bug tracking. The predictions made by the improved predictive analytics system can then be used to provide better scheduling and resource allocations.

Improved Predictive Analytics System

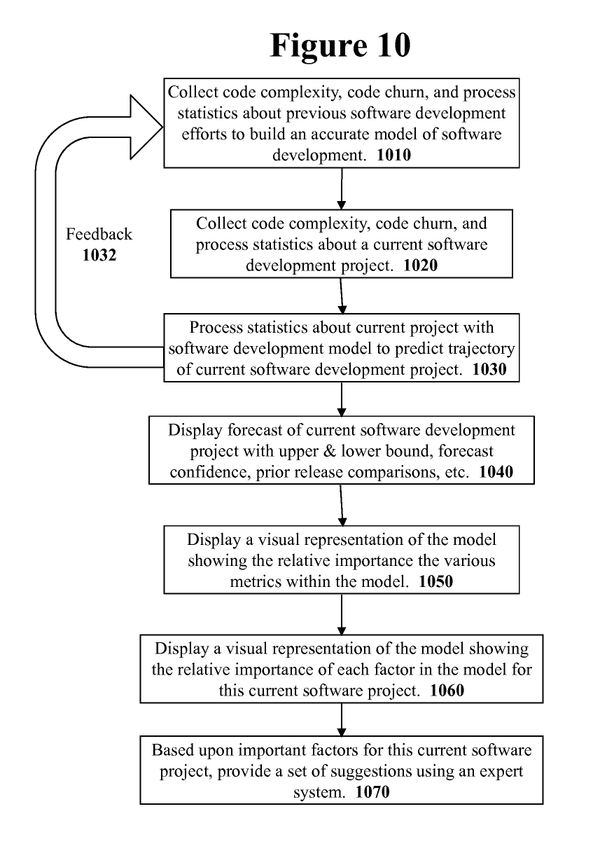

To fully describe how the predictive analytics system of the present disclosure operates, a full example of its application is disclosed with reference to the flow chart of FIG. 10. Initially, the predictive analytics system collects information from past software development projects at stage 1010. The previously described code complexity, code churn, and process metrics are collected to extent possible. The more information that is collected, the better the predictions will generally be. Ideally, the information is collected from the same development team and same development tools that will be used on current software development projects. Note that the information collection is mostly automated such that little human work is required the needed development metrics.

The predictive analytics system then builds a statistical model of the software development process based upon all of the information collected. The statistical model correlates the various code complexity, code churn, and process metrics to an observed set of software defect rates. Referring back to FIG. 5E, statistical model 550 forms a large knowledgebase gathered from past experience.

Next, at stage 1020, the system collects a set of code complexity, code churn, and process metrics for a current software development project. As set forth in the previous sections, the collection of these metrics is largely performed in a manner that is completely transparent to the programmers and managers working on the project. Referring back to FIG. 5E, an integration layer 570 of the predictive analytics system 500 collects the various metrics from programming tool systems such as a source code control system 581, a bug tracking system 583, a customer feedback system 585, a quality assurance and test system 587, and a feature request tracking system 589. All of the collected metrics are stored in a current project development metrics database 530.

Referring back to FIG. 10, at stage 1030 the predictive analytics system then processes the current project's collected metrics 530 with a predictive engine 521 that draws upon the experience of the past as encoded within the statistical model 550. Many different techniques may be used to perform this processing. In one particular embodiment, the system performs Principle Component Regression (which is one part of Principle component analysis).

During the processing of the current project's collected metrics 530, the predictive analytics system 500 may feedback some of the recent collected metrics from the current project into the statistical model 550. In this manner, the predictive analytics system 500 is continually updated with more recent experience. Furthermore, the information stored within the statistical model 550 may be weighted depending on the age of the information. By continually adding new information and weighting the information by age, the predictive analytics system 500 will continually adjust the predictions made based upon the way the software development team changes their practices. Thus, as a software development team uses a predictive analytics system 500, that software development team will change the way they work based upon the advice they receive from the predictive analytics system 500. This in turn will change defect rates. Thus, having a feedback system that continually adjusts the statistical model 550 of the predictive analytics system 500 with the latest information will ensure that predictions continue to be accurate.

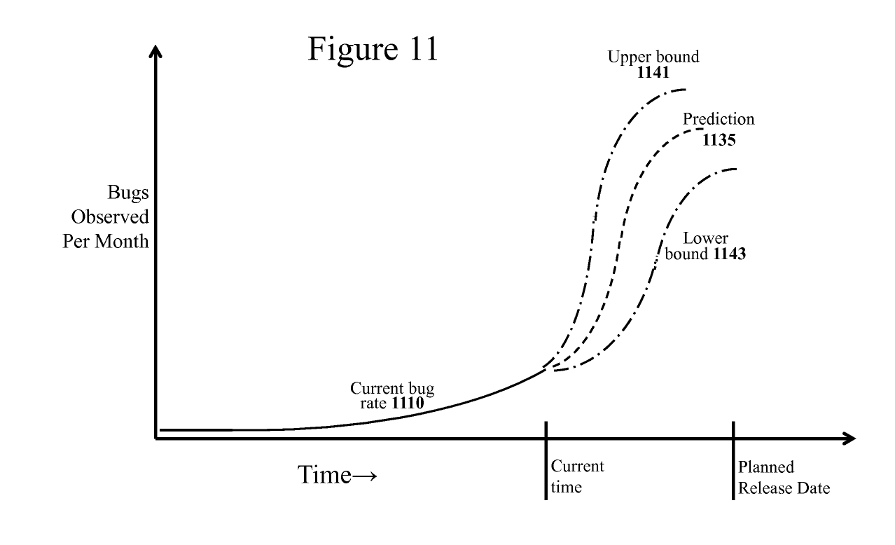

After analyzing the current state of a software development project as reflected in the current project's collected metrics 530, the predictive analytics system 500 will display a forecast of the current software development project at stage 1140. FIG. 11 illustrates an example of a graphical display of a specific bug forecast prediction 1135 that may be provided by the predictive analytics system 500. The forecast may include a confidence interval defined between an upper bound 1141 and lower bound 1143. The forecast may also include a confidence level that specifies how confident the predictive analytics system 500 is with the forecast. The forecast may also be displayed with reference to bug rates of prior releases (not shown) such that a software manager can determine if the team is doing better or worse.

Displaying the forecast provides some useful information to the software manager. However, to provide more useful information, additional displays of information are made available to the software manager using the predictive analytics system 500. Thus, at stage 1050, the system displays a visual representation of the model that shows the relative importance of the various metrics. In one embodiment, the relative importance is displayed with a colored coding system. This display allows a software manager to know which metrics are very important to handle properly. Conversely, this also allows the software manager to see which factors are not very important and probably not worth focusing on. The relative importance of the metrics is extracted from the statistical model 550 of the predictive analytics system 500. Note that the importance of the metrics will depend on what the system learned from the previous software development projects. Thus, for the best advice, the system should use a collection of metrics collected from the same development team and tools.

After displaying the important metrics in the model, the system may then proceed to stage 1060 where the predictive analytics system displays the most important metrics affecting the current predictions. Thus, specific issues with the current software development project may be causing abnormally large risks. For example, a set of popularly used global variables may be introducing a high-risk to this particular project even though that is not often a problem with this team's projects. By highlighting the specific factors that are most important for this project, the software manager can take direct actions to address those issues. In one embodiment, the user is able to change certain metrics to see how the changes adjust the forecast. In this manner the user can see how different changes to the development process will affect the outcome.

Finally, at stage 1070, the predictive analytics system 500 may employ an expert system 527 to process the current predictions 525 and output a set of specific recommendations to address the most high risk areas of the current software development project. For example, a set of general recommendations for minimizing the risks presented the metrics identified in stage 1050 has highly important to the model will be presented. Similarly, the expert system 527 may include a set of specific recommendations for addressing the specific problem areas identified in stage 1060 that are strongly affecting this current software development project.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim is still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

We claim:

1. A method of analyzing a computer software development project, said method comprising:
constructing a statistical software development model from previous software development experience;
collecting a set of code complexity metrics, said set of code complexity metrics derived a plurality of source code files;
collecting a set of code churn metrics, said set of code complexity metrics derived from a source code control system;
tracking bugs discovered in said computer software development project;
processing said set of code complexity metrics, said set of code churn metrics, and said bugs with predictive analysis engine using said statistical software development; and
outputting a set of predictions describing the future development trajectory of said computer software development project.

2. The method of analyzing a computer software development project as set forth in claim 1, said method further comprising:
collecting a set of development process metrics;
wherein said system further processes said set of development process with said predictive analysis engine.

3. The method of analyzing a computer software development project as set forth in claim 1, said method further comprising:
collecting a set of testing metrics;
wherein said system further processes said testing metrics with said predictive analysis engine.

4. The method of analyzing a computer software development project as set forth in claim 1 wherein said processing comprises using Bayesian inference.

5. The method of analyzing a computer software development project as set forth in claim 1 wherein said processing comprises using a support vector machine.

6. The method of analyzing a computer software development project as set forth in claim 1 wherein said processing comprises using Principle Component Regression.

7. The method of analyzing a computer software development project as set forth in claim 1 wherein said processing comprises using logistic regression.

8. The method of analyzing a computer software development project as set forth in claim 1 wherein said set of predictions describing the future development trajectory of said computer software development project comprise an internal bug rate.

9. The method of analyzing a computer software development project as set forth in claim 1 wherein said set of predictions describing the future development trajectory of said computer software development project comprise a customer found defect rate.

10. The method of analyzing a computer software development project as set forth in claim 1 wherein said set of predictions describing the future development trajectory of said computer software development project comprise an identification of high-risk source code sections.

11. The method of analyzing a computer software development project as set forth in claim 1, said method further comprising:
displaying a visual representation of said predictive analysis engine that indicates a relative importance of a set of input metrics.

12. The method of analyzing a computer software development project as set forth in claim 11 wherein said relative importance is displayed with color coding.

13. The method of analyzing a computer software development project as set forth in claim 1, said method further comprising:
displaying a visual representation of said predictive analysis engine that indicates a relative importance of said set of code complexity metrics and said set of code churn metrics.

14. The method of analyzing a computer software development project as set forth in claim 13 wherein said relative importance is displayed with color coding.

15. The method of analyzing a computer software development project as set forth in claim 1, said method further comprising:
processing said set of predictions describing the future development trajectory of said computer software development project with an expert system; and
outputting a set of software development recommendations from said expert system.

16. The method of analyzing a computer software development project as set forth in claim 1, said method further comprising:
reading said set of predictions describing the future development trajectory of said computer software development project with an integration layer; and
adjusting bug priority levels in a bug tracking system based on said set of predictions describing the future development trajectory of said computer software development project.

17. A computer readable medium, said computer-readable medium storing a set of computer instructions for analyzing a computer software development project, said computer instructions implementing the steps of:
constructing a statistical software development model from previous software development experience;
collecting a set of code complexity metrics, said set of code complexity metrics derived a plurality of source code files;
collecting a set of code churn metrics, said set of code complexity metrics derived from a source code control system;
tracking bugs discovered in said computer software development project;
processing said set of code complexity metrics, said set of code churn metrics, and said bugs with predictive analysis engine using said statistical software development; and
outputting a set of predictions describing the future development trajectory of said computer software development project.

18. The computer readable medium storing said set of computer instructions as set forth in claim 17, said computer instructions further implementing steps of:
collecting a set of development process metrics;
wherein said system further processes said set of development process with said predictive analysis engine.

19. The computer readable medium storing said set of computer instructions as set forth in claim 17 wherein said processing comprises using Principle Component Regression.

20. The computer readable medium storing said set of computer instructions as set forth in claim 17, said computer instructions further implementing steps of
processing said set of predictions describing the future development trajectory of said computer software development project with an expert system; and
outputting a set of software development recommendations from said expert system.
